(19) United States
(12) Patent Application Publication
(10) Pub. No.: US 2011/0240717 A1
(43) Pub. Date: Oct. 6, 2011

(54) COMPONENT MOUNTING METHOD AND DEVICE MANUFACTURED USING THE SAME

(75) Inventors: Xueliang Song, Tokyo (JP); Katsumasa Horiguchi, Tokyo (JP); Foo Cheong Yit, Tokyo (JP); Shurong Wang, Tokyo (JP)

(73) Assignee: ADVANCED PHOTONICS, INC., Tokyo (JP)

(21) Appl. No.: 13/132,757

(22) PCT Filed: Nov. 26, 2009
(86) PCT No.: PCT/JP2009/069939

§ 371 Date: Jun. 3, 2011

(30) Foreign Application Priority Data
Dec. 3, 2008 (JP) 2008-308449

(51) Int. Cl. B23K 1/20; B23K 31/02

(52) U.S. Cl. 228/180.22; 228/203; 228/256; 228/101; 228/33

(57) ABSTRACT

The present invention provides technology for mounting components with simple processing and with comparatively high dimensional precision. Welding sections (21) and non-welding sections (31) are formed on a surface of a substrate (1) by transferring a mask pattern. Next, fusing material (4) is arranged on the welding sections (21), and the fusing material (4) is fused to the welding sections (21). The fusing material (4) is positioned with comparatively high dimensional precision using the non-welding sections (31). Next, a component (5) is mounted on the substrate (1) with the fusing material (4) that has been fused to the welding sections (21) as positioning guides. In this way, it is possible to mount the component (5) on the substrate (1) with high dimensional precision.

### BACKGROUND OF THE INVENTION

1. Field of the Invention

The present invention relates to a method of mounting components on a main body, and to a device manufactured using this method.

2. Description of the Related Art

Patent documents 1 and 2 describe technology for mounting optical components such as optical fiber on a substrate.

With these technologies, it is intended to mount components on the substrate with high dimensional precision by forming grooves on the substrate and mounting components for positioning on the substrate. However, with these technologies there have the disadvantages that processing for mounting the components on the substrate is complicated, and the cost is likely to be increased.

Also, patent document 3 discloses technology for patterning a conductive layer for wiring, and carrying out positioning of components using this conductive layer (that is, the wiring pattern). However, corresponding time and cost are required in order to form the wiring to a thickness at which positioning of optical fiber is possible.

Patent document 1
International Publication W02004/042444

Patent document 2
Japanese patent laid-open No. 2007-264517
Patent document 3
Japanese patent laid-open No. 2005-234557

### SUMMARY OF THE INVENTION

The present invention has been conceived in view of the above-described circumstances.

One object of the present invention is to provide technology for mounting components with simple processing and with comparatively high dimensional precision.

The present invention is comprised of the disclosure of any of the following aspects.

(Aspect 1)

A component mounting method, comprising the following steps:
(1) A step of forming a welding section and a non-welding section adjacently on the surface of a main body;
(2) a step of arranging fusing material on the welding section and welding the fusing material to the welding section; and
(3) a step of mounting components on the main body with the fusing material that has been welded to the welding section as a positioning guide.

With the present invention, it is possible to carry out positioning of fusing material in a melted state with comparatively high dimensional precision, using the non-welding section adjacent to the welding section. Also with the present invention, since positioning of components is carried out using fusing material that has been fused to the welding section, it becomes possible to simplify processing and to keep the costs for manufacturing a device low. Here fusing of the fusing material and the welding section can be carried out, for example, by heating the fusing material after the fusing material has been placed on an upper surface of the welding section.

(Aspect 2)

The component mounting method of aspect 1, wherein the welding section and the non-welding section are formed in predefined shapes by transferring a mask pattern.

With this invention, since the welding section and the non-welding section are formed by transferring a mask pattern, it is possible to increase the relative positional precision between welding sections, and the relative positional precision between the welding section and the non-welding section.

(Aspect 3)

The component mounting method of aspect 1 or aspect 2, wherein the fusing material is solder, the welding section is composed of metal, and the non-welding section is composed using solder resist layers, and further,

the non-welding section is formed close to the welding section and raised sections for positioning the fusing material are provided.

With this aspect of the invention, it is possible to carry out positioning of the fusing material using raised sections of the non-welding section formed using solder resist layers.

(Aspect 4)

The component mounting method of aspect 3, wherein the fusing material is formed into a substantially ball shape, in a state before being fused to the welding section.

By using substantially ball shaped solder as the fusing material is possible to make the operation of arranging the solder on the welding section much more efficient. Also, the volume of the ball shaped solder can be set with comparatively high precision by controlling the manufacturing process of the solder. Accordingly, by using ball shaped solder, it becomes possible to improve the precision of positioning the components. In this invention a ball shape is not limited to a sphere, and it is possible to have an elliptical globular shape or a polyhedral shape.

(Aspect 5)

The component mounting method of aspect 4, wherein side surfaces of the fusing material bulge out in the direction of the non-welding section, in a state of being fused to the welding section.

By using the side surfaces that bulge out in the direction of the non-welding section it is possible to reduce the possibility of the component riding up on the upper parts of the solder. With this invention it therefore become possible to further improve the mounting precision of the component.

(Aspect 6)

The component mounting method of aspect 1 or aspect 2, wherein the fusing material is solder, the welding section is composed of metal, and the non-welding section is composed using a material having low wettability with respect to the solder.

With the invention of this aspect, it is difficult for solder that has been arranged on the welding section to spread towards the material that has low wettability with respect to solder. Accordingly, with this invention it is possible to demonstrate a function of positioning fusing material using the non-welding section.

(Aspect 7)

The component mounting method of any one of aspects 1 to 6, wherein a covering layer formed of a material that is harder than the fusing material is arranged on the surface of the fusing material.

By providing a cover layer it is possible to prevent deformation of the fusing material. In this way it is possible to further improve the precision of mounting a component.

(Aspect 8)

The component mounting method of aspect 1, wherein the welding section and the non-welding section are formed in predefined shapes by photolithography.

With the invention of this aspect, it is possible to form the welding section and the non-welding section in predefined shapes using photolithography technology. Here, photolithography is technology for, for example, after exposing a film for making the welding section and the non-welding section to light and altering it, removing “one of either altered sections or unaltered sections” by a suitable method such as etching. As means of exposure, as well as ultraviolet light exposure that uses a photo mask, it is possible to use various technologies, such as laser exposure for carrying out exposure by scanning laser light.

(Aspect 9)

The component mounting method of any one of aspects 1 to 8, wherein indents for forming contact surfaces or contact lines with the surface of the fusing material are formed on the component, and

the component is positioned with respect to the fusing material by arranging all or part of the fusing material inside the indents.

Forming indents in the component and bringing these indents into contact with fusing material, it is possible to position the component and the fusing material easily and with high dimensional precision.

(Aspect 10)

A device comprising a main body, a component, and fusing material,

the main body comprising a welding section and a non-welding section,

the welding section being formed of a material that is easy to weld to the fusing material,

the non-welding section being formed of a material that is difficult to weld to the fusing material, and

the non-welding section is arranged adjacent to the welding section, wherein

the fusing material is fused to the welding section in a state of being adjacent to the non-welding section, and

the component is mounted on the main body with the fusing material as a positioning guide.

According to the present invention, it is possible to provide technology for mounting a component with simple processing and with comparatively high dimensional precision.

### BRIEF DESCRIPTION OF THE DRAWINGS

FIG. 1 is an explanatory drawing for explaining a component mounting method of a first embodiment of the present invention, and shows a cross-section of a substrate.

FIG. 2 is flowchart for explaining the component mounting method of the first embodiment of the present invention.

FIG. 3 is an explanatory drawing for explaining a component mounting method of a second embodiment of the present invention, and shows a cross-section of a substrate.

FIG. 4 is an explanatory drawing for explaining a component mounting method of a third embodiment of the present invention, and shows a cross-section of a substrate.

FIG. 5 is an explanatory drawing for explaining a component mounting method of a fourth embodiment of the present invention, and shows a plan view of a substrate.

FIG. 6 is an explanatory drawing for explaining a component mounting method of a fifth embodiment of the present invention, and shows a cross-sectional view of a substrate.

FIG. 7 is an explanatory drawing for explaining a component mounting method of a sixth embodiment of the present invention, and shows a plan view of a substrate.

FIG. 8 is an explanatory drawing for explaining a component mounting method of a seventh embodiment of the present invention, and shows a cross-section of a substrate.

FIG. 9 is an explanatory drawing for explaining a component mounting method of an eighth embodiment of the present invention, and shows a plan view of a substrate.

FIG. 10 is an explanatory drawing for explaining a component mounting method of a ninth embodiment of the present invention, and shows a cross-section of a substrate.

FIG. 11 is an explanatory drawing for explaining a component mounting method of a tenth embodiment of the present invention, and shows a cross-section of a substrate.

FIG. 12 is an explanatory drawing for explaining a component mounting method of an eleventh embodiment of the present invention, and shows a cross-section of a substrate.

FIG. 13 is an explanatory drawing for explaining the component mounting method of the eleventh embodiment of the present invention, and shows a cross-section of the substrate.

FIG. 14 is an explanatory drawing for explaining a component mounting method of a twelfth embodiment of the present invention, and shows a cross-section of a substrate.

FIG. 15 is an explanatory drawing for explaining a component mounting method of a thirteenth embodiment of the present invention, and shows a cross-section of a substrate.

FIG. 16 is an explanatory drawing for explaining a component mounting method of a fourteenth embodiment of the present invention, and shows a cross-section of a substrate.

FIG. 17 is an explanatory drawing for explaining a component mounting method of a fifteenth embodiment of the present invention, and shows a cross-section of a substrate.

FIG. 18 is an explanatory drawing for explaining the component mounting method of the fifteenth embodiment of the present invention, and shows a state where a component is placed on an upper part of solder.

FIG. 19 is an explanatory drawing for explaining a component mounting method of a sixteenth embodiment of the present invention, and shows a plan view of a substrate. FIG. 19(a) shows a state where a metal film is formed on a sub-mount, and FIG. 19(b) shows a state where solder is placed on an upper part of the metal film.

FIG. 20 is an explanatory drawing for explaining a component mounting method of a seventeenth embodiment of the present invention, and shows a cross-section of a substrate.

FIG. 21 is an explanatory drawing for explaining the component mounting method of the seventeenth embodiment of the present invention. FIG. 21(a) shows a plan view of a substrate before placing a component on the substrate, and FIG. 21(b) shows a plan view of the substrate after placing a component on the substrate.

FIG. 22 is an explanatory drawing for explaining a component mounting method of an eighteenth embodiment of the present invention, and shows a cross-section of a substrate.

FIG. 23 is an explanatory drawing for explaining the component mounting method of the eighteenth embodiment of the present invention. FIG. 23(a) shows a plan view of a substrate before placing a component on the substrate, and FIG. 23(b) shows a plan view of the substrate after placing a component on the substrate.

FIG. 24 is an explanatory drawing for explaining a component mounting method of a nineteenth embodiment of the present invention, and shows a cross-section of a substrate.

FIG. 25 is an explanatory drawing for explaining the component mounting method of the nineteenth embodiment of the present invention. FIG. 25(a) shows a plan view of a substrate before placing a component on the substrate, and FIG. 25(b) shows a plan view of the substrate after placing a component on the substrate.

FIG. 26 is an explanatory drawing for explaining a component mounting method of a twentieth embodiment of the present invention, and shows a cross-section of a substrate.

FIG. 27 is an explanatory drawing for explaining the component mounting method of the twentieth embodiment of the present invention, and shows a cross-section of the substrate.

FIG. 28 is an explanatory drawing for explaining the component mounting method of the twentieth embodiment of the present invention, and shows a plan view of a substrate, with a component mounted on the substrate.

### DESCRIPTION OF THE PREFERRED EMBODIMENTS

### First Embodiment

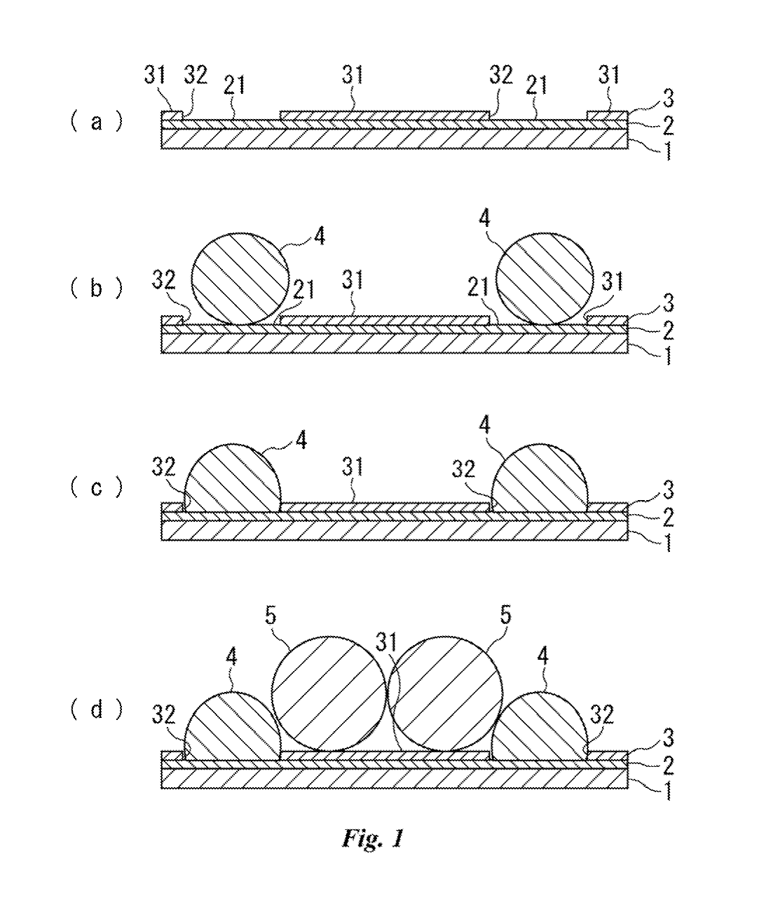

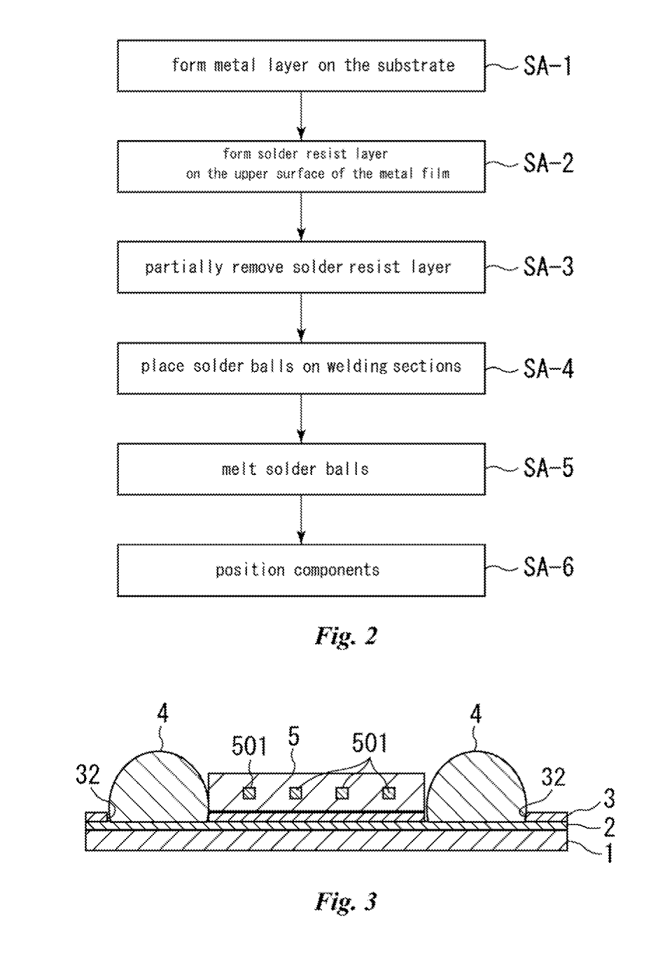

A component mounting method of the first embodiment of the present invention will be described based on FIG. 1 and FIG. 2.

(Step SA-1 of FIG. 2)

First, a metal film 2 is formed on an upper surface of a substrate 1 (refer to FIG. 1(a)). The substrate 1 corresponds to one example of the main body of the present invention. In this embodiment, copper foil formed from copper alloy can be used as the metal film 2. As metal that can be used as the metal film 2, as well as a copper alloy, it is possible to use, for example, gold, aluminum, or an alloy of either. In short, it is possible to use, as the metal film 2, a material that can be fused with solder, being a fusing material that will be described later.

(Step SA-2 of FIG. 2)

Next, a solder resist layer 3 is formed on the surface of the metal film 2. With this embodiment, a solder resist layer 3 is formed over the whole of the upper surface of the metal film 2, but is also possible to form the solder resist layer 3 only at necessary locations. With this embodiment, a resin having low wettability to solder can be used as a material for the solder resist layer 3. Epoxy type resin can be given as one example of such a resin.

(Step SA-3 of FIG. 2)

Next, the solder resist layer 3 is partially removed using a mask pattern. Specifically, first a mask pattern (not shown in the drawings) is mounted on an upper surface of the solder resist layer 3. After that, the solder resist layer 3 is exposed by irradiating with light (for example, ultraviolet light) from an upper surface of the mask pattern. Next, the exposed portions are removed by etching. In this way, as shown in FIG. 1(a), the solder resist layer 3 is partially removed and it is possible to expose part of the metal film 2. That is, with this embodiment, it is possible in this way to transfer a mask pattern onto the solder resist layer 3.

With this embodiment, welding sections 21 are made using the metal film 2 that has been exposed to the outside by removing the solder resist layer 3. Also, the non-welding sections 31 are formed using the remaining solder resist layer 3. Further, raised sections 32 are formed on the non-welding sections 31 at parts adjacent to the welding sections 21, since the welding sections themselves have a certain thickness (refer to FIG. 1(a)). With this embodiment the raised sections 32 surround the periphery of the welding sections 31. In the above description, exposed portions are removed, but it is also possible, conversely, to adopt means for removing non-exposed sections depending on choice of material.

(Step SA-1 of FIG. 2)

Next, fusing material 4 is placed on the welding sections 21 (refer to FIG. 1(b)). Here in this embodiment, solder balls can be used as the fusing material 4. Solder balls are solder that has been formed into ball shapes.

(Step SA-5 of FIG. 2)

Next as a result of heating the fusing material 4, the fusing material 4 is melted and fused to the welding sections 4. Specifically, for example, the entire assembly, including the substrate 1 itself, is placed in a reflow furnace and heated. Since the melting temperature of the solder is generally much lower than the melting temperature of the solder resist layer 3, the metallic film 2, and the substrate 1, it is possible to melt only the solder.

The melted solder is deformed along the shape of the non-welding sections 31 that have been formed on the solder resist layer 3. As a result, with this embodiment it is possible to carry out positioning of the solder using the non-welding sections 31 that are adjacent to the welding sections 21.

Also with this embodiment, since the raised sections 32 are formed at the periphery of the welding sections 21, the position of the solder is regulated by the raised sections 32. As a result, with this embodiment it is possible to carry out positioning of the solder much more reliably.

(Step SA-6 of FIG. 2)

Next, components 5 are mounted on the substrate 1 with the fusing material 4 that has been fused to the welding sections 21 as positioning guides. With this embodiment, two optical fibers are used as one example of the components 5.

With this embodiment, because the welding sections 21 and the non-welding sections 31 are formed by mask pattern transfer, relative positional precision between welding sections 21, as well as relative positional precision between welding sections 21 and non-welding sections 31, can be made high. If general transfer technology is assumed, the relative positional precision can be considered to be about ±10 λm. If errors are of about this magnitude, then it can be considered that there will be sufficient precision in connection between optical components.

Also, with this embodiment, since positioning of the components 5 is carried out using fusing material that has fused to the welding sections 21, mounting processing is easy and it becomes possible to keep the cost of manufacturing a device low.

Accordingly, the mounting method of this embodiment has the advantages that mounting processing is simple and it is possible to realize high mounting precision. In particular, with this embodiment there is the advantage that it is possible to realize high mounting position, of an extent required for positioning of optical components (for example, light emitting and receiving elements and optical fibers) with simple processing.

A unit (device) manufactured using this embodiment is provided with a substrate 1 as a main body, components 5, and fusing material 4, as shown in FIG. 1(d). The main body 1 comprises welding sections 21 and non-welding sections 31.

The welding sections 21 and the non-welding sections 31 are formed by transferring a mask pattern. The welding sections 21 are formed of a material that is easy to fuse with the fusing material 4, such as metal. The non-welding sections 31 are formed using a material that is difficult to weld to the fusing material 4, for example, a solder resist layer.

The non-welding sections 31 are arranged adjacent to the welding sections 21. The fusing material 4 is fused to the welding sections 21 in a state of being adjacent to the non-welding sections 21.

The components 5 are mounted on the substrate 1 with the fusing material 4 as positioning guides. With this embodiment, the fusing material 4 is shaped having an upper part that is narrow, and gradually widening out. As a result, a distance between each fusing material 4 in this embodiment becomes gradually narrower moving downwards. Accordingly, with this embodiment, there are the advantages that mounting of components 5 is easy, and positioning of components with high dimensional precision is possible. Further, with this embodiment, since solder is used as the fusing material 4, it is possible to easily form the solder into the previously described shape of becoming wider towards the bottom by melting the solder and using the surface tension of the solder. However, this type of positioning function can also be demonstrated in cases where intermediate portions of the fusing material 4 have the widest width. If ball shaped solder is used, this type of shape can be comparatively easily formed.

In the description of this embodiment, the fusing material has been exemplified by solder balls, but is also possible to use solder paste. When solder paste is used, it is preferable to precisely control the applied amount. It is also possible to use solder that has been formed into stripe shapes as the fusing material. In this case, it is possible to arrange the elongated solder strips in the depth direction of the drawing sheet of FIG. 1.

Also, with this embodiment, the welding sections 21 and the non-welding sections 31 have been formed using a mask pattern, but it is also possible to omit use of a mask pattern by using laser exposure technology. In the case of laser exposure also, since positional precision of laser irradiation is high, it is possible to make positional precision of the welding sections 21 and the non-welding sections 31 high.

### Second Embodiment

Next, a second embodiment of the present invention will be described with reference to FIG. 3. In the description of the second embodiment, the same reference numerals will be used for elements that are the same as in the previous described first embodiment, and complicated description will be avoided.

With this second embodiment, plate-like optical waveguides are used as the components 5. As shown in this embodiment, in the case of plate-like optical waveguides also, it is possible to carry out positioning by having side surfaces of the optical waveguides abut against the fusing material 4. Reference numerals 501 in FIG. 3 represent core sections of the optical waveguides.

The remaining structure and advantages of the second embodiment are the same as those of the previously described first embodiment, and so description of any further detail will be omitted.

### Third Embodiment

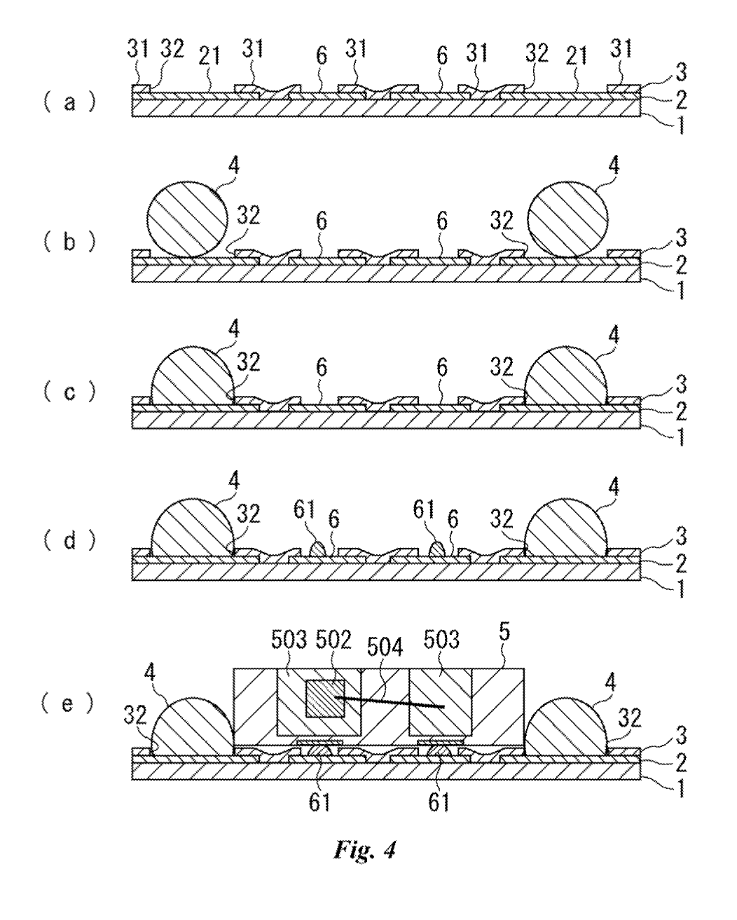

Next, a third embodiment of the present invention will be described with reference to FIG. 4. In the description of the third embodiment, the same reference numerals will be used for elements that are the same as in the previous described first embodiment, and cumbersome description will be avoided.

With this third embodiment, in addition to the welding sections 21, electrical wiring 6 is formed on the upper surface of the substrate 1. This electrical wiring 6 can also be formed using so-called photolithography technology (refer to FIG. 4 (a))

With this embodiment also, similarly to the first embodiment, the fusing material 4 is placed on the welding sections 21 (refer to FIG. 4(b)). After that, it is possible to fix the fusing material 4 and the welding sections 21 by melting the fusing material 4 (refer to FIG. 4(c)).

Next, with this third embodiment, a conductive adhesive 61 is placed on the electrical wiring 6 (refer to FIG. 4(d)).

Also, with this embodiment, sub-mounts for light emitting and receiving elements are used as the components 5. With this embodiment also the components 5 can be positioned using the fusing material 4. Reference numerals 504 in FIG. 4 represent light emitting and receiving elements, numerals 503 represent side electrodes, and numeral 504 represents a gold wire for connection.

Further, with this embodiment, it is possible to press the conductive adhesive 61 against electrodes of the sub-mounts, as components 5, and it is possible to electrically connect the sub-mounts and the electrical wiring 6.

Also, with this embodiment, the periphery of the conductive adhesive 61 can be surrounded by a solder resist layer 3 having a certain thickness. With this embodiment therefore, there is an advantage that it is possible to reduce the risk that the conductive adhesive 61 will stick out at the periphery to make a short-circuit between adjacent electrodes.

Instead of the conductive adhesive 61 in this third embodiment, it is possible to use solder having a lower melting point than the solder used as the fusing material 4. In this case, it is possible to electrically connect between the sub-mounts and the electrical wiring 6 by heating the low melting point solder to an extent that the fusing material 4 does not melt.

### Fourth Embodiment

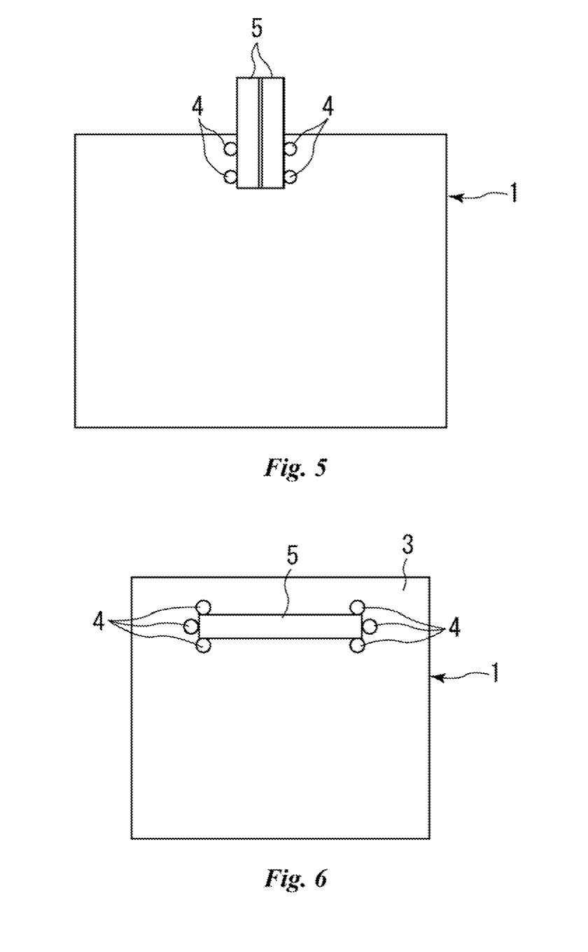

Next, a component mounting method of a fourth embodiment of the present invention will be described based on FIG. 5. In this example, as shown in FIG. 5, the fusing material 4 is arranged on an upper surface of the substrate 1 at four locations, and positioning of the components 5 is carried out using these fusing materials 4.

In this way, it becomes possible to uniquely determine a position of a component 5 in the width direction by arranging the fusing material 4 at three or more locations.

The remaining structure and advantages of the fourth embodiment are the same as those of the previously described first embodiment, and so for the fourth embodiment description of any further detail will be omitted.

### Fifth Embodiment

Next, a component mounting method of a fifth embodiment of the present invention will be described based on FIG. 6. In this example, as shown in FIG. 6, the fusing material 4 is arranged on an upper surface of the substrate 1 at 6 locations, and positioning of the components 5 is carried out using these fusing materials 4.

Also, with this embodiment, three pieces of fusing material 4 are arranged on each end of a component 5. The components 5 of this embodiment are sub-mounts.

By arranging the fusing material 4 in each of the directions in which a component 5 may move, as in this embodiment, it becomes possible to uniquely determine the position of a component 5 on the substrate.

The remaining structure and advantages of the fifth embodiment are the same as those of the previously described first embodiment, and so for the fifth embodiment description of any further detail will be omitted.

### Sixth Embodiment

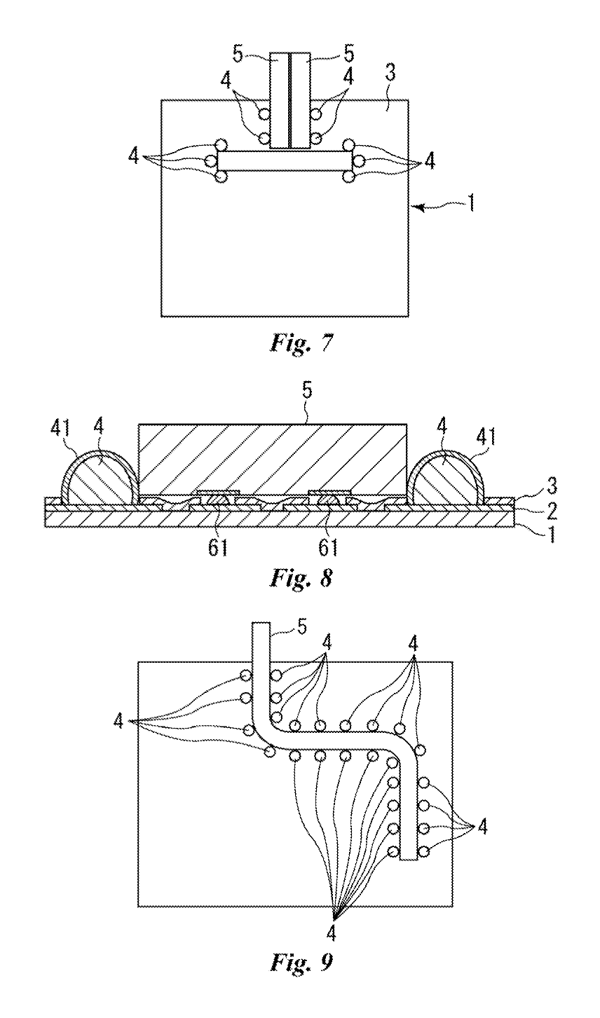

Next, a component mounting method of a sixth embodiment of the present invention will be described based on FIG. 7. In this example, as shown in FIG. 7, the fusing material 4 is arranged on an upper surface of the substrate 1 at a total of 10 locations, and positioning of two types of component 5 is respectively carried out using these fusing materials 4. Specifically, this sixth embodiment is a combination of the positioning method in the fourth embodiment and the positioning method in the fifth embodiment.

By arranging the fusing material 4 as in this embodiment, it becomes possible to carry out positioning of, for example, optical fibers and sub-mounts with high dimensional precision.

The remaining structure and advantages of the sixth embodiment are the same as those of the previously described fourth and fifth embodiments, and so for the sixth embodiment description of any further detail will be omitted.

### Seventh Embodiment

Next, a component mounting method of a seventh embodiment of the present invention will be described based on FIG. 8. With this embodiment, a cover layer 41 that is harder than the fusing material 4 is coated on the surface of the fusing material 4. As a material for the cover layer 41 it is possible to use a material that is harder than the fusing material 4, such as, for example, nickel alloy or titanium alloy. Also, as means for fixing the cover layer 41 to the fusing material, it is possible to use plating, for example.

According to the method of the seventh embodiment, since deformation of the fusing material 4 due to external force on the fusing material 4 can be prevented by the cover layer 41, it becomes possible to reliably exhibit the positioning function using the fusing material 4. In particular, since there is a lot of conveying within a factory, there is a possibility of impact being applied to the fusing material 4 due to dropping of the substrate etc. This advantage is therefore important for practical utilization of the technology of the present invention.

The remaining structure and advantages of the seventh embodiment are the same as those of the previously described second embodiment, and so description of any further detail will be omitted.

### Eighth Embodiment

Next, a component mounting method of an eighth embodiment of the present invention will be described based on FIG. 9. With this embodiment, numerous pieces of the fusing material 4 are arranged on the upper surface of the substrate 1, along the longitudinal direction of an optical fiber, as a component 5.

According to the method of the seventh embodiment, in the case where an elongated material such as an optical fiber is used as the component 5, it is possible to arrange the component 5 on the substrate 1 while it is being bent or deformed into an arbitrary shape.

The remaining structure and advantages of the eighth embodiment are the same as those of the previously described first embodiment, and so description of any further detail will be omitted.

### Ninth Embodiment

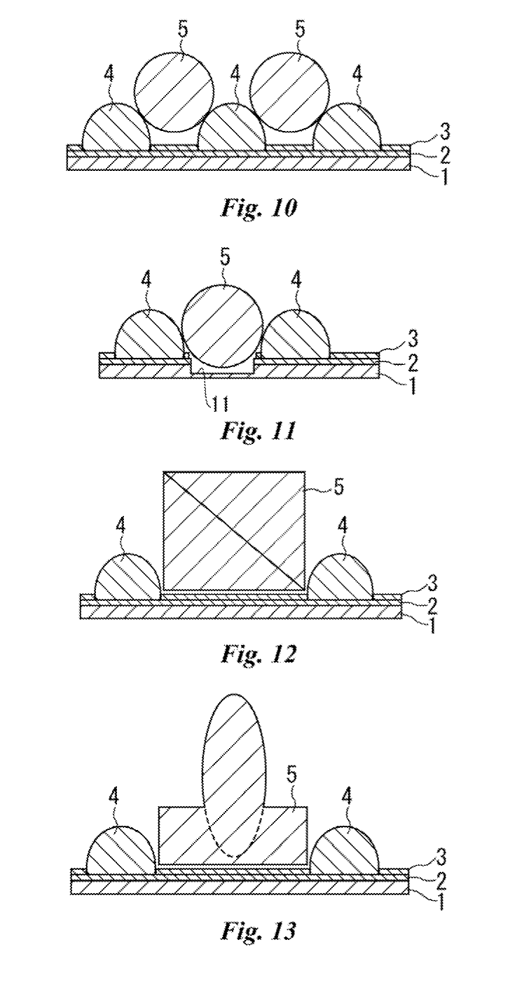

Next, a component mounting method of a ninth embodiment of the present invention will be described based on FIG. 10. With this embodiment, a distance between fusing material 4 is set narrower than the width of a component 5.

According to this ninth embodiment, it is possible to arrange components 5 on the substrate 1. Specifically, with this embodiment, it is possible to position components 5 above the substrate 1.

The remaining structure and advantages of the ninth embodiment are the same as those of the previously described first embodiment, and so description of any further detail will be omitted.

### Tenth Embodiment

Next, a component mounting method of a tenth embodiment of the present invention will be described based on FIG. 11. With this embodiment, a distance between fusing materials 4 is set slightly wider than the case of the first embodiment, with respect to the width of a component 5. Further, with this embodiment, a groove 11 is formed on the upper surface of the substrate

According to this tenth embodiment, it is possible to arrange components 5 at positions that sink into the substrate 1, by bringing the components 5 into contact with the fusing material 4.

Also, with this embodiment, since the groove 11 is formed on the substrate 1 it is possible to avoid interference between the components 5 and the substrate 1.

The remaining structure and advantages of the tenth embodiment are the same as those of the previously described first embodiment, and so description of any further detail will be omitted.

### Eleventh Embodiment

Next, a component mounting method of an eleventh embodiment of the present invention will be described based on FIG. 12 and FIG. 13. With the example shown in FIG. 12, a mirror is used as a component 5. Also, with the example shown in FIG. 13, a lens is used as the component 5. The method of the present invention is effective in mounting various optical components that require precise optical axis alignment.

The remaining structure and advantages of the eleventh embodiment are the same as those of the previously described first embodiment, and so description of any further detail will be omitted.

### Twelfth Embodiment

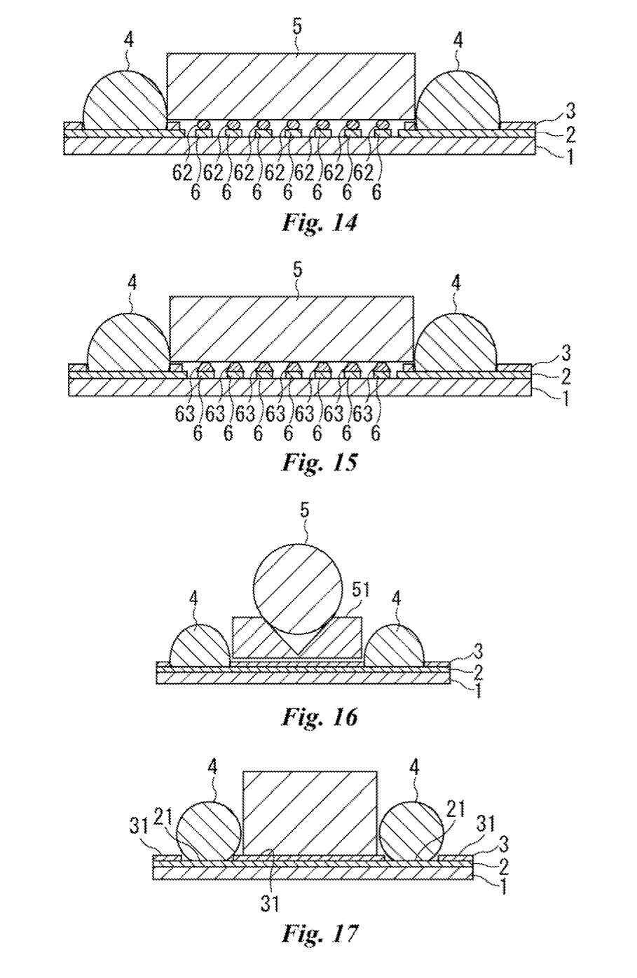

Next, a component mounting method of a twelfth embodiment of the present invention will be described based on FIG. 14. With the example shown in FIG. 14, an electronic component such as an IC is used as a component 5. Also, with the example shown in FIG. 14, solder material 62 having a normal melting point a low melting point is arranged between the electrical wiring 6 and the components 5 formed on the substrate 1. On the other hand, a high melting point solder material is used as the fusing material 4 in this example.

According to this twelfth embodiment, it is possible to electrically connect the component 5 and the electrical wiring 6 by placing the substrate in a reflow furnace. Further, with this embodiment, since the fusing material 4 is made a high melting point solder, melting of the fusing material 4 is avoided and it is possible to ensure positional precision for the component 5.

The remaining structure and advantages of the twelfth embodiment are the same as those of the previously described first embodiment, and so description of any further detail will be omitted.

### Thirteenth Embodiment

Next, a component mounting method of a thirteenth embodiment of the present invention will be described based on FIG. 15. With the example shown in FIG. 15, an electronic component such as an IC is used as the component 5. Also, with the example shown in FIG. 14, conductive adhesive 63 is arranged between the electrical wiring 6 formed on the substrate 1 and the components 5. On the other hand, a high melting point or normal melting point solder material is used as the fusing material 4 in this example.

According to the method of this thirteenth embodiment, it is possible to electrically connect between components 5 and electrical wiring 6 on the one hand, and it is possible to avoid melting the fusing material 4 to ensure positional precision for the components 5.

The remaining structure and advantages of the thirteenth embodiment are the same as those of the previously described first embodiment, and so description of any further detail will be omitted.

### Fourteenth Embodiment

Next, a component mounting method of a fourteenth embodiment of the present invention will be described based on FIG. 16. With the example shown in FIG. 16, a retainer 51 is arranged between the components 5 and the substrate 1. With this example therefore, the retainer 51 is positioned using the fusing material 4, and optical fiber as the component 5 is positioned using the retainer 51. In this way, the present invention includes indirect positioning of components 5 by means of a retainer.

According to this embodiment there is the advantage that it is possible to easily adjust the height of a component 5 by selecting the shape of the retainer 51.

The remaining structure and advantages of the fourteenth embodiment are the same as those of the previously described first embodiment, and so description of any further detail will be omitted.

### Fifteenth Embodiment

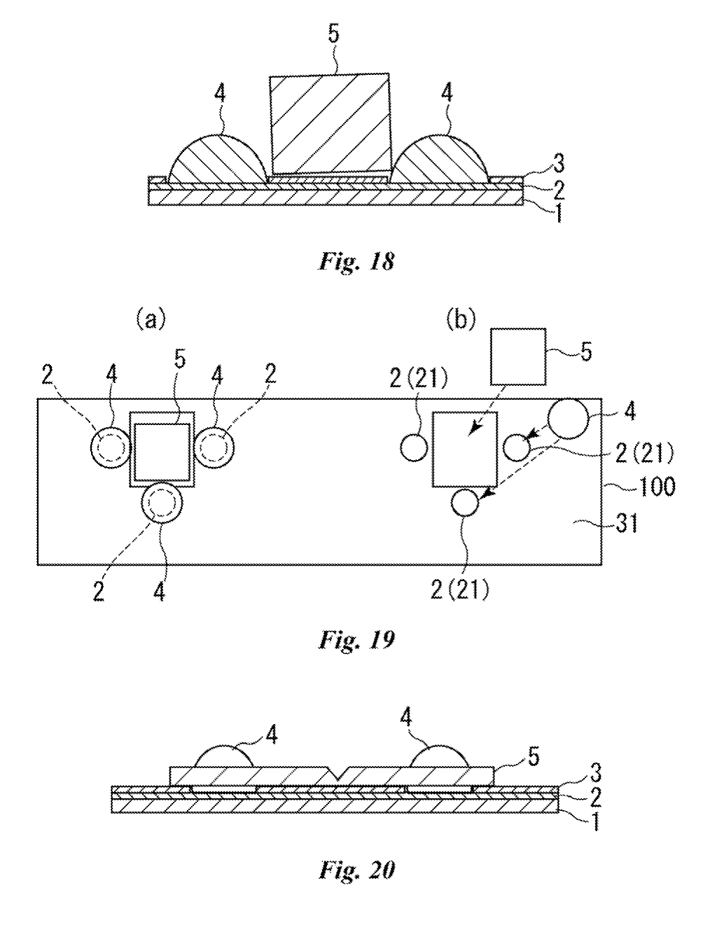

Next, a component mounting method of a fifteenth embodiment of the present invention will be described based on FIG. 17 and FIG. 18. With the example shown in FIG. 17, side surfaces of the fusing material 4 bulge out in the direction of the non-welding sections 31, in a state of being fused to the welding sections 21. A structure such as that in FIG. 17 can be comparatively easily realized by making the surface area of the welding sections 21 small.

As shown in FIG. 18, depending on the shape of a component 5, there is a possibility of the component 5 riding up onto the fusing material 4 and the component 5 being tilted. If a state such as in FIG. 18 comes about, it is difficult to ensure mounting precision of the component. Reasonable care is therefore required in the operation of placing the component 5 on the substrate 1.

In contrast to this, with this embodiment, using the side surfaces that bulge out in the direction of the non-welding sections 31 it is possible to reduce the possibility of the components 5 riding up on the upper parts of the fusing material 4. It is therefore possible, with this embodiment, to further improve the mounting precision of the components.

With this embodiment also, similarly to the case of the first embodiment, the shape of the fusing materials 4 narrows at the top. As a result, with this embodiment also, there are the advantages that it is easy to arrange components 5, and positioning with good precision becomes possible.

The remaining structure and advantages of the fifteenth embodiment are the same as those of the previously described first embodiment, and so description of any further detail will be omitted.

### Sixteenth Embodiment

Next, a component mounting method of a sixteenth embodiment of the present invention will be described based on FIG. 19.

In each of the previously described embodiments a substrate 1 was used as a main body. However, with this sixteenth embodiment a sub-mount 100 is used as the main body. This sub-mount 100 is constructed using ceramics or a glass epoxy resin. Specifically, this sub-mount 100 is constructed using ceramics having AlN as a main constituent.

Also, with each of the above-described embodiments, a solder resist layer 3 was used, but with this sixteenth embodiment the solder resist layer 3 is not used.

In the sixteenth embodiment, a metal film 2 is adhered to the surface of the sub-mount 100 using an appropriate method such as sputtering or vacuum vapor deposition (refer to FIG. 19(a)). At this time, position and shape of the metal film 2 can be set as desired using a mask pattern. Also, the adhered metal film 2 constitutes the welding sections 21. Here, with this embodiment, a surface of the sub-mount 100 that exists around the welding sections 21 is of a material having low wettability with respect to the solder that is made the fusing material 4. Generally, ceramics and resin have low wettability with respect to solder. Accordingly, with this embodiment the surface of the sub-mount 100 around the welding sections 21 constitutes the non-welding sections 31.

Then, the fusing material 4 is placed on the welding sections 21 (refer to FIG. 19(b)). Further, the fusing material 4 is heated to be welded to the welding sections 21. At this time, the non-welding sections 31 around the welding sections 21 have low wettability with respect to the fusing material 4, and so the melted fusing material 4 stops in the range of the welding sections 21. Accordingly, with this embodiment also it is possible to mount the fusing material 4 on the sub-mount 100 with high dimensional precision.

Next, using the fusing material 4 as guides, it is possible to mount light emitting and receiving elements, as components 5, with high dimensional precision on the sub-mount 100.

Using the above structure, with this embodiment “welding sections are formed using metal, and non-welding sections are formed using material having low wettability with respect to solder”.

The remaining structure and advantages of the sixteenth embodiment are the same as those of the previously described first embodiment, and so description of any further detail will be omitted.

### Seventeenth Embodiment

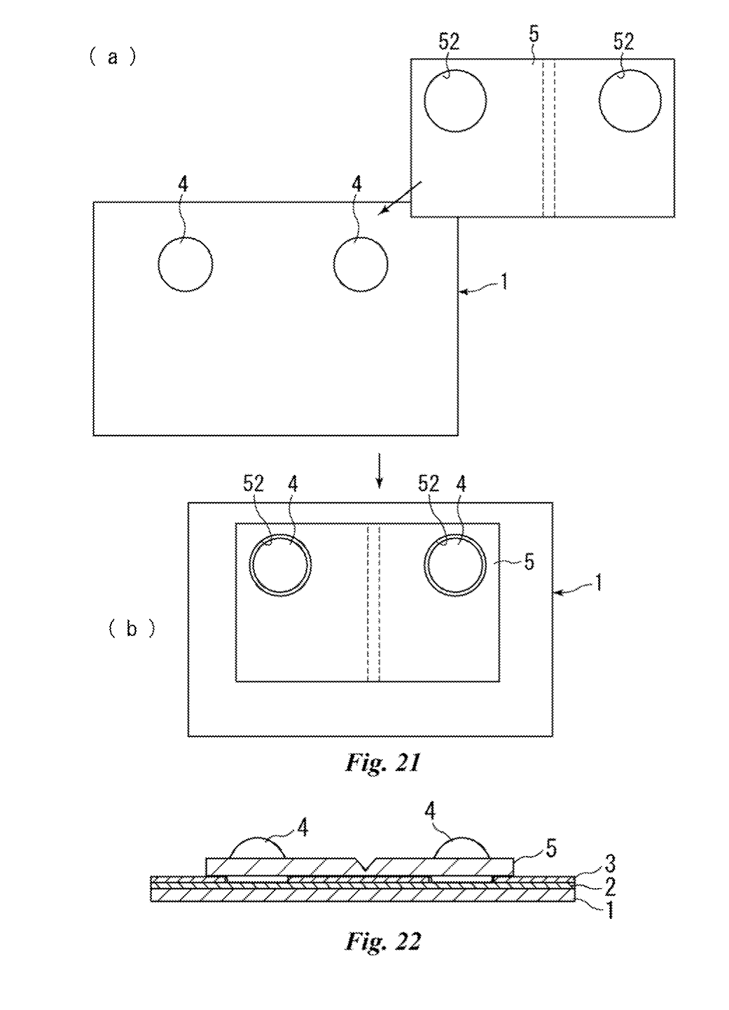

Next, a component mounting method of a seventeenth embodiment of the present invention will be described based on FIG. 20 and FIG. 21.

Indents 52 for forming contact surfaces or contact lines with the surface of the fusing material 4 are formed on a component 5 of the seventeenth embodiment. These indent 52 are formed using through holes passing through the components 5 in this embodiment.

A component 5 is positioned with respect to the fusing material 4 by arranging the fusing material 4 inside the indents (refer to FIG. 21(b). Specifically, by contacting an inner surface of an indent 52 with the surface of the fusing material 4, a positional relationship between the two is determined. Here, a contact state between the fusing material 4 and the indent 52 can be considered to be contact between surfaces, contact between a surface and a line, or contact a surface and a plurality of points (for example, a plurality of projections formed on an inner surface of the indent). In summary, contact between the fusing material 4 and the indent 52 can be what determines the position relationship between the two.

With this embodiment, indents 52 are formed on components 5, and by contacting these indents 52 with the fusing material 4 it is possible to carry out positioning of the components 5 and the fusing material 4 easily, and with high dimensional precision. Also, with this embodiment, even if the number of pieces of fusing material 4 is low, a component 5 can be positioned with high dimensional precision, and so it becomes possible to reduce the material and mounting space for the fusing material 4.

The remaining structure and advantages of the seventeenth embodiment are the same as those of the previously described first embodiment, and so description of any further detail will be omitted.

### Eighteenth Embodiment

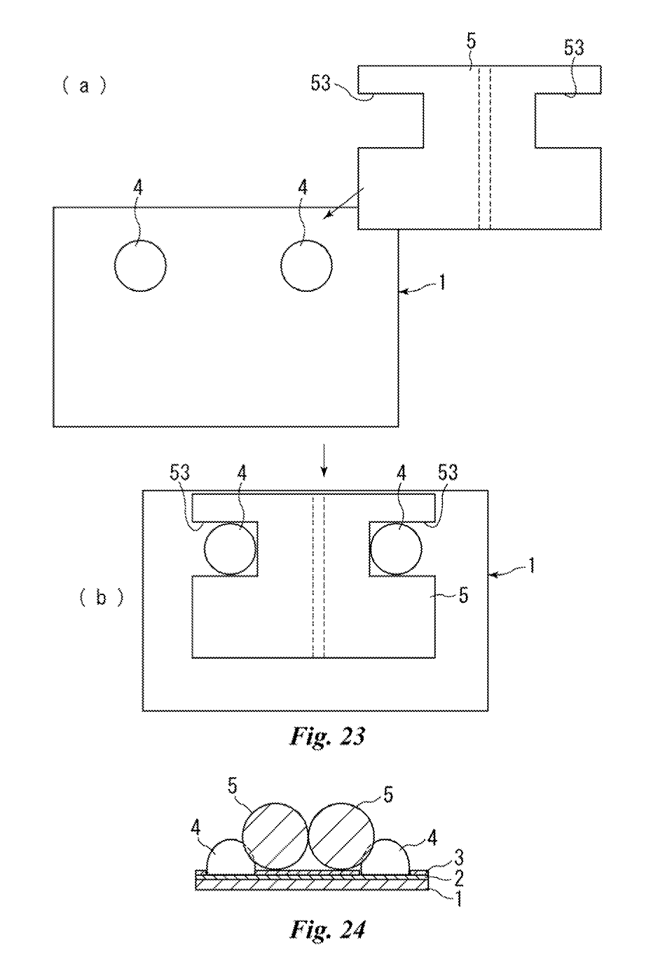

Next, a component mounting method of an eighteenth embodiment of the present invention will be described based on FIG. 22 and FIG. 23.

Indents 53 for forming contact surfaces or contact lines with the surface of the fusing material 4 are formed on a component 5 of the eighteenth embodiment. These indents 53 are formed using cutouts in the side surfaces of the components 5 in this embodiment.

A component 5 is positioned with respect to the fusing material 4 by arranging the fusing material 4 inside the indents 53 (refer to FIG. 23(b). Specifically, by contacting three side surfaces of an indent 53 with the surface of the fusing material 4, a positional relationship between the two can be determined.

With this embodiment, indents 53 are formed on a component 5, and by contacting these indents 53 with the fusing material 4 it is possible to carry out positioning of the component 5 and the fusing material 4 easily, and with high dimensional precision.

The remaining structure and advantages of the eighteenth embodiment are the same as those of the previously described seventeenth embodiment, and so description of any further detail will be omitted.

### Nineteenth Embodiment

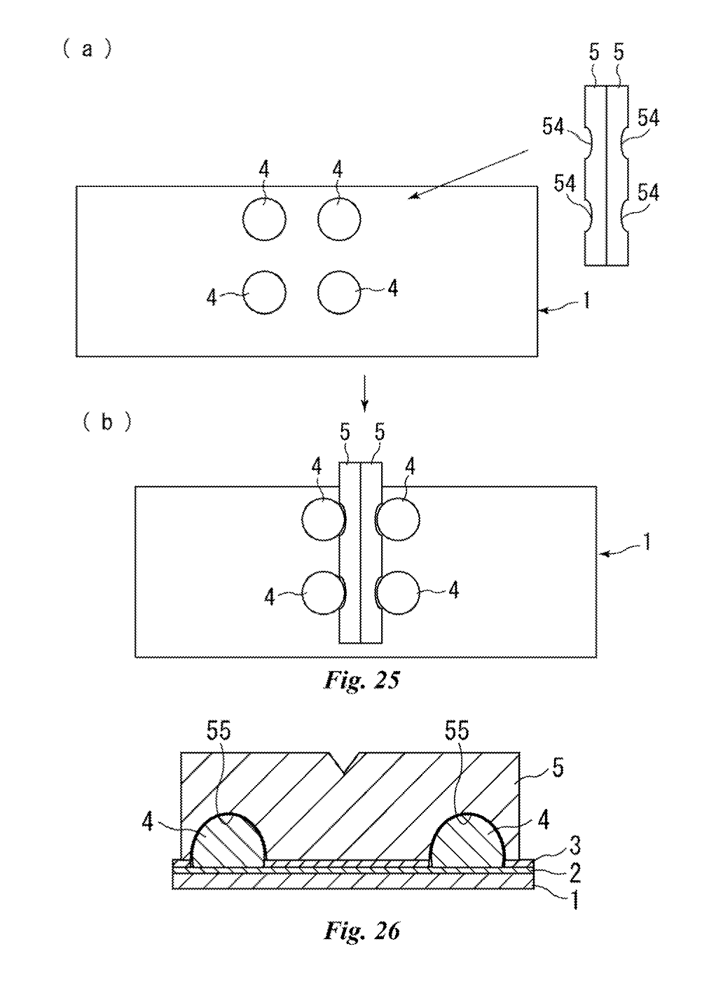

Next, a component mounting method of a nineteenth embodiment of the present invention will be described based on FIG. 24 and FIG. 25.

A component 5 of the nineteenth embodiment is constituted by optical fiber. Indents 54 for forming contact surfaces or contact lines with the surface of the fusing material 4 are formed on side surfaces of a component 5. These indents 54 are formed by partially removing the side surfaces of the component 5 in this embodiment. In a case where a component 5 is a plastic optical fiber (POF), this type of shape can be easily formed. However, even if an optical fiber is a quartz fiber, if a resin coating section of the outer side of the fiber is made the subject of shape modification, this type of processing is comparatively easy.

A component 5 is positioned with respect to the fusing material 4 by arranging the fusing material 4 inside the indents 54 (refer to FIG. 25(b). Also, with this embodiment, there is the advantage that it is possible to carry out positioning of an optical fiber in the propagation direction of light with high dimensional precision.

With this embodiment, indents 54 are formed on components 5, and by contacting these indents 54 with the fusing material 4 it is possible to carry out positioning of the components 5 and the fusing material 4 easily, and with high dimensional precision. As shown in FIG. 17, even in the case where the fusing material 4 bulges out laterally, the fusing material 4 is contained in the indents 54, and it is possible to carry out positioning of the components 5. In this case, side surfaces of the fusing material 4 and the inner surfaces of the indents 54 come into contact.

The remaining structure and advantages of the nineteenth embodiment are the same as those of the previously described seventeenth embodiment, and so description of any further detail will be omitted.

### Twentieth Embodiment

Next, a component mounting method of a twentieth embodiment of the present invention will be described based on FIG. 26 to FIG. 28.

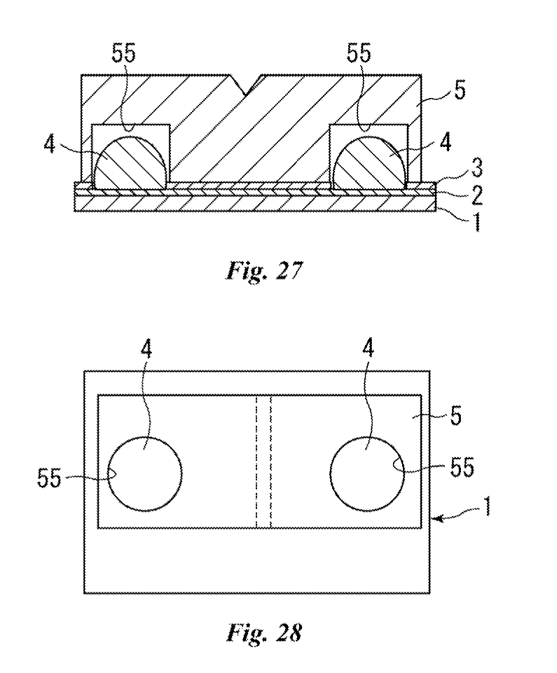

Indents 55 for forming contact surfaces or contact lines with the surface of the fusing material 4 are formed on bottom surfaces of components 5 of the twentieth embodiment. These indents 55 are formed by depressing or removing the bottom surface of a component 5. FIG. 26 shows an example where the indents 55 are made a substantially spherical shape. Also, FIG. 27 shows an example where the indents 55 are in a substantially cylindrical shape, with an axis of the indents being arranged in the vertical direction in the drawing.

A component 5 is positioned with respect to the fusing material 4 by arranging the fusing material 4 inside the indents 55 (refer to FIG. 26 and FIG. 27).

With this embodiment, indents 55 are formed on components 5, and by contacting these indents 55 with the fusing material 4 it is possible to carry out positioning of the components 5 and the fusing material 4 easily, and with high dimensional precision.

The remaining structure and advantages of the twentieth embodiment are the same as those of the previously described seventeenth embodiment, and so description of any further detail will be omitted.

The content of the present invention is not limited to the above-described embodiments. It will be understood that various modifications may be added to the present invention with respect to the specific structure, within the scope of the appended patent claims.

1. A component mounting method, comprising the following steps:
(1) a step of forming a welding section and a non-welding section adjacently on a main body surface;
(2) a step of arranging fusing material on the welding section and fusing the fusing material to the welding section; and
(3) a step of mounting a component on the main body with the fusing material that has been fused to the welding section as a positioning guide.

2. The component mounting method of claim 1, wherein the welding section and the non-welding section are formed in predefined shapes by transferring a mask pattern.

3. The component mounting method of claim 1 or claim 2, wherein the fusing material is solder, the welding section is composed of metal, and the non-welding section is composed using solder resist layers, and further,
the non-welding section is formed close to the welding section and comprises a raised section for positioning the fusing material.

4. The component mounting method of claim 3, wherein the fusing material is formed into a substantially ball shape, in a state before being fused to the welding section.

5. The component mounting method of claim 4, wherein side surfaces of the fusing material bulge out in the direction of the non-welding section, in a state of being fused to the welding section.

6. The component mounting method of claim 1, wherein the fusing material is solder, the welding section is composed of metal, and the non-welding section is composed using a material having low wettability with respect to the solder.

7. The component mounting method of claim 1, wherein a covering layer formed of a material that is harder than the fusing material is arranged on the surface of the fusing material.

8. The component mounting method of claim 1, wherein the welding section and the non-welding section are formed in predefined shapes by photolithography.

9. The component mounting method of claim 1, wherein indents for forming contact surfaces or contact lines with the surface of the fusing material are formed on the component, and
the component is positioned with respect to the fusing material by arranging all or part of the fusing material inside the indents.

10. A device comprising a main body, components and fusing material,
the main body comprising a welding section and a non-welding section,
the welding section being formed of a material that is easy to fuse with the fusing material,
the non-welding section being formed of a material that is difficult to weld to the fusing material, and
the non-welding section being arranged adjacent to the welding section, wherein
the fusing material is welded to the welding section in a state of being adjacent to the non-welding section, and
the component is mounted on the main body with the fusing material as a positioning guide.
